(19) United States
(12) Patent Application Publication
(10) Pub. No.: US 2025/0346451 A1
(43) Pub. Date: Nov. 13, 2025

(54) ELEVATOR SYSTEM AND ELEVATOR OPERATING DEVICES FOR DIFFERENT OPERATING MODES

(71) Applicant: Inventio AG, Hergiswil (CH)

(72) Inventors: Dennys Taiana, Losone (CH); Gabriele Hofmann, Minusio (CH)

(21) Appl. No.: 18/871,409

(22) PCT Filed: Jun. 6, 2023
(86) PCT No.: PCT/EP2023/065032

§ 371 Date: Dec. 3, 2024

(30) Foreign Application Priority Data
Jun. 29, 2022 (EP) 22181928.7

(51) Int. Cl. B66B 1/46

(52) U.S. Cl. CPC B66B 1/463; B66B 1/468; B66B 2201/463

(57) ABSTRACT

An elevator operating device has a bus interface device, a storage device, a screen system and a control device. The storage device stores configuration data and electronic instructions for selectable operating modes of the elevator operating device, wherein a first operating mode is designed for processing an elevator call that indicates a direction of travel, and wherein a second operating mode is designed for processing an elevator call that indicates a destination floor. The screen system is designed to depict a graphical user surface on a touch-sensitive screen. The control device is designed to read the configuration data and the electronic instructions for a selected operating mode from the storage device and to operate the elevator operating device according to the selected operating mode.

### TECHNICAL FIELD

The present disclosure relates in general to an elevator installation. Embodiments of the present disclosure relate, in particular, to an elevator operating device, to the use thereof in an elevator system, and to a method for operating such an elevator operating device.

### SUMMARY

In buildings with elevator systems, elevator operating devices, by means of which a passenger can call an elevator, are arranged on the individual floors. According to known elevator system control technology, an elevator operating device arranged on a floor has mechanical pushbuttons which the person can use to input the desired direction of travel (up/down). This control technology shall also be referred to hereinafter as up/down direction controller. When one of these buttons is pressed, an elevator call is input, whereupon an elevator controller confirms the elevator call on the elevator operation device and provides an elevator car on the floor for boarding. For example, an elevator car is moved to the floor (boarding floor) and its elevator door is opened. A car operating device (car calling device) is provided in the elevator car, by means of which the person in the elevator car can input the desired destination floor; this also being referred to as car call.

According to additional known control technology, also known as a destination call controller, an elevator operating device arranged on a floor has buttons or fields displayed on a touch-sensitive screen that are assigned to individual destination floors. By pressing or touching a button assigned to the desired destination floor, an elevator call known as a destination call can be input. The boarding floor and the destination floor are determined by inputting a destination call. A call can then no longer be input in the elevator car.

Elevator systems equipped with a destination call controller can advantageously be used in buildings having a large number of floors and a correspondingly high volume of traffic. In contrast, elevator systems with an up/down direction controller are used in buildings with a relatively small number of floors. An elevator system is also known in which both control technologies are used, for example, from U.S. Pat. No. 7,766,129 B2. In this elevator system, two types of elevator operating devices are installed in the building. For example, for cost reasons, an elevator operating device with destination call control is only provided for a floor with a high volume of traffic. Although these known approaches use volume of traffic when selecting the control technology and the associated costs, some buildings, and thus also the elevator system provided therein, may have different or even more extensive building-specific requirements. There is therefore a need for a technology that allows these requirements to be better met.

One aspect of the present disclosure can relate to an elevator operating device that can comprise a bus interface device, a storage device, a screen system and a control device communicatively connected to the bus interface device, the screen system and the storage device. The bus interface device can be configured to communicate with an elevator controller of an elevator system via the communication bus system. The storage device can store configuration data and electronic instructions for selectable operating modes of the elevator operating device. A first operating mode can be configured for processing an elevator call indicating a direction of travel, and a second operating mode can be configured for processing an elevator call indicating a destination floor. The screen system has a touch-sensitive screen and can be configured to display a graphical user surface on the touch-sensitive screen. The control device can be configured to read the configuration data and the electronic instructions for a selected operating mode from the storage device and to operate the elevator operating device according to the selected operating mode.

A further aspect of the present disclosure can relate to an elevator system that can comprise a plurality of such elevator operating devices. The elevator system can also comprise an elevator controller, at least one elevator car that can move between floors of a building under the control of the elevator controller and driven by a drive machine, and a communication bus system. The elevator operating devices can be communicatively connected to the communication bus system and can be arranged on the floors for inputting an elevator call.

An additional aspect of the present disclosure can relate to a method for operating an elevator operating device in such an elevator system. The elevator operating device can be connected to the communication bus system of the elevator system. The method can comprise generating a configuration input mask on the graphical user surface that the touch-sensitive screen of the screen system displays under the control of the control device of the elevator operating device. The configuration mask can comprise a first selection input field for the first operating mode of the elevator operating device and a second selection input field for the second operating mode of the elevator operating device. When the screen system detects that the first selection input field has been touched, configuration data and electronic instructions for the first operating mode can be read from the storage device and the elevator operating device can be configured for the first operating mode in accordance with the configuration data and electronic instructions that are read. When the screen system detects that the second selection input field has been touched, configuration data and electronic instructions for the second operating mode can be read from the storage device and the elevator operating device can be configured for the second operating mode in accordance with the configuration data and electronic instructions that are read.

According to one embodiment of the present disclosure, among other things, an elevator operating device can be provided that stores configuration data and electronic instructions for a plurality of selectable operating modes of the elevator operating device. The elevator operating device can therefore be adapted on site to an elevator system and its requirements in a building. This means, for example, that the elevator operating device can be configured to input and process an elevator call that indicates the direction of travel, or that it can be configured to input and process an elevator call that indicates the destination floor. A single elevator operating device can therefore either be configured for one operating mode or the other operating mode as required.

Both operating modes can also be used in an elevator system. For example, an elevator operating device on a first floor may be configured for the first operating mode, while an elevator operating device on a second floor may be configured for the second operating mode, for example. Despite the different operating modes, the two elevator operating devices can have, according to one embodiment, the same external appearance or design.

For the on-site configuration described herein, it may be advantageous that the control device of the elevator operating device can be configured to activate the screen system to display a configuration input mask on the graphical user surface. The configuration mask can comprise a first selection input field for the first operating mode and a second selection input field for the second operating mode. When the first selection input field is touched, the elevator operating device can be configured for the first operating mode according to the configuration data and the electronic instructions. When the second selection input field is touched, the elevator operating device can be configured for the second operating mode according to the configuration data and the electronic instructions.

The configuration input mask can be configured such that an operating mode is simply and intuitively selected. After the selection is made, the elevator operating device may configure itself.

In an embodiment that may be applicable in conjunction with one or more of the embodiments described herein, the control device can be configured to activate the screen system to display direction of travel fields on the graphical user surface in the first operating mode, and to activate the screen system to display destination floor fields on the graphical user surface in the second operating mode. The direction of travel fields can be displayed in the known manner. The destination floor fields can comprise numbers and/or floor information (e.g., names, parking level, information on services (e.g., restaurant), etc.). In addition, further information can be displayed in accordance with the two operating modes.

In an embodiment that may be applicable in conjunction with one or more of the embodiments described herein, the control device can be configured to generate a first request message in the first operating mode that can comprise an address of the elevator controller, an ID of the elevator operating device, and a direction of travel, and to generate a second request message in the second operating mode that can comprise the address of the elevator controller, the ID of the elevator operating device and an indication of a destination floor. In each operating mode, the request message may be sent to the elevator controller via the bus interface device and the communication bus system.

In an embodiment that may be applicable in conjunction with one or more of the embodiments described herein, the bus interface device may store data and instructions for specific communication bus technologies, in particular, their transmission methods, communication protocols and/or frame structures. The bus interface device can be configured to communicate via the communication bus system according to one of the stored communication bus technologies. Since the bus interface device may store characteristics of said bus technologies, the elevator operating device can be bus-independent and can be selectively connected to any communication bus system that is designed according to bus technology that is suitable for use in an elevator system.

In an embodiment that may be applicable in conjunction with one or more of the embodiments described herein, the elevator controller can be communicatively connected to the communication bus system and can be configured to provide the car on the first floor upon receipt of an elevator call indicating a direction of travel from an elevator operating device arranged on a first floor and configured for the first operating mode, and to move the car to the destination floor upon receipt of a car call input in the car and indicating a destination floor.

In an embodiment that may be applicable in conjunction with one or more of the embodiments described herein, the elevator controller can be communicatively connected to the communication bus system and can be configured to provide the car on the first floor upon receipt of an elevator call indicating a destination floor from an elevator operating device arranged on a first floor and configured for the second operating mode, and to move the car to the destination floor indicated in the elevator call upon receipt of a status signal indicating that the elevator door is closed.

In an embodiment that may be applicable in conjunction with one or more of the embodiments described herein, the elevator system can further comprise a destination call control device that is communicatively connected to the elevator controller and the communication bus system.

### BRIEF DESCRIPTION OF THE DRAWINGS

Various aspects of the present disclosure are described in greater detail herein in conjunction with the drawings with reference to example embodiments. In the figures, identical elements have identical reference signs. In the drawings:

FIG. 1 is a schematic representation of an example situation in a building with multiple floors and of an example elevator installation;

FIG. 2A-2C are schematic representations of example user surfaces of an elevator operating device which is arranged on a floor in the elevator system according to FIG. 1;

FIG. 3A-3D are schematic representations of possible applications of the elevator operating device; and

FIG. 4 is a schematic representation of an example elevator operating device; and

FIG. 5 is an example representation of an embodiment of a method for operating an elevator operating device.

### DETAILED DESCRIPTION

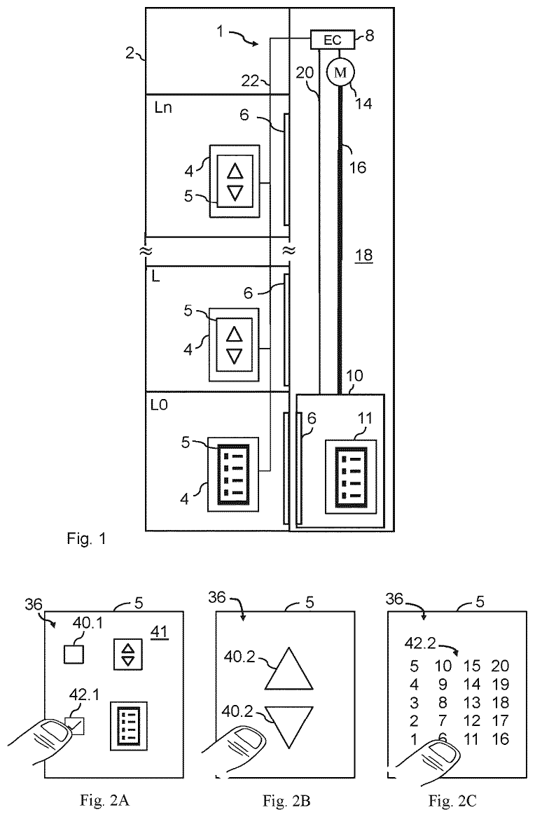

FIG. 1 is a schematic representation of an example situation in a building 2 that has multiple floors L0, L, Ln that are served by an elevator installation 1. The floor L0 can be an entrance hall of the building 2 which people enter when entering the building 2 and from which they leave the building 2 again. If a person enters the floor L0, each floor L, Ln of the building 2 served by the elevator system 1 can be reached—with appropriate access authorization—from this floor. For illustrative purposes, only an elevator controller 8, a drive machine 14, lifting gear 16 (e.g., steel cables or flat belts), an elevator car 10 (hereinafter also referred to as a car 10), which is suspended on the lifting gear 16 and is movable in a hoistway 18, and a plurality of elevator operating devices 4, which are communicatively connected to the elevator controller 8 with a communication bus system 22, of the elevator system 1 are shown in FIG. 1. A person skilled in the art will recognize that the elevator system 1 can also comprise multiple cars 10 in one or more shafts 18 that are controlled by a group controller. Instead of a traction elevator (shown in FIG. 1), the elevator system 1 can also have one or more hydraulic elevators.

In the embodiment described herein of the elevator system 1, the person on one of the floors L0, L, Ln can input a travel request at an elevator operating device 4 arranged on said floor, as a result of which an elevator call may be registered. The floor L0, L, Ln on which the person is located when the call is input and from which they would like to be transported to a destination floor can also be referred to herein as the boarding floor or call input floor. As explained in more detail herein, the person can touch a button or a displayed field to input the call, whereupon the person may be given acknowledgment that the elevator call has been registered at the elevator operating device 4, for example, the button or field can light up. The elevator controller 8 may then provide an elevator car 10 on the boarding floor for boarding. In other words, if the elevator car 10 is not on the boarding floor, it may be moved there and its elevator door may be opened together with a hoistway door. Otherwise the car door of the elevator car 10 that is already there may only be opened, whereby the shaft door is also opened. The car door and the hoistway doors are given reference numeral 6 in FIG. 1. On a floor L0, L, Ln on which the car 10 is located, the shaft door and the car door located there each form an elevator door 6.

In FIG. 1, the elevator controller 8 is an up/down direction controller. The elevator operating devices 4 arranged on the floors L, Ln can be configured to display buttons or fields for inputting a desired direction of travel (up or down). The elevator operating device 4 arranged on the floor L0 can be configured to display buttons or fields for inputting a destination floor. A person skilled in the art will recognize that this arrangement and the design of the elevator operating devices 4 are examples.

FIG. 1 also shows a car calling device 11 arranged in the elevator car 10. The car calling device 11 is connected to the elevator controller 8 with a communication line 20. A destination floor can be input at this car calling device 11 (car call), in particular, when a person on the floor L, Ln can input the desired direction of travel. The availability of the car calling device 11 for inputting a call may depend on the building 2 and/or the elevator system 1. Depending on the situation, the car calling device 11 may, for example, be activated or deactivated, and may also be covered up when not in use.

The elevator operating devices 4 each have a screen system (5, 37) which comprises a touch-sensitive screen 5 (hereinafter also referred to as a touchscreen 5) and a screen controller 37 (FIG. 4). A control device 50 (CPU) provided in the elevator operating device 4 (FIG. 4) can activate the screen controller 37 to display a graphical user surface 36 (FIG. 4) with content appropriate to the situation on the touchscreen 5. A person skilled in the art will recognize that this activation can be performed according to the current situation of the elevator system 1.

When an elevator operating device 4 is operated for the first time, e.g., in conjunction with operating the elevator system 1 for the first time or at a later point in time, the elevator operating device 4 can be in a basic state. According to one embodiment, the elevator operating device 4 may not be configured for any of the operating modes described herein in this basic state. In the basic state, in particular, the screen system and a configuration interface device 34 shown in FIG. 4 can be activated so that the elevator operating device 4 can be configured for an operating mode. For example, the touchscreen 5 can show a configuration input mask 41 shown in FIG. 2A on the graphical user surface 36. The configuration input mask 41 can be displayed, for example, after a technician has activated a configuration mode by inputting a password, for example.

The configuration mask 41 shown comprises, for example, a first selection input field 40.1, the selection of which can configure the elevator operating device 4 for inputting a direction call and a corresponding operating mode, and a second selection input field 42.1, the selection of which can configure the elevator operating device 4 for inputting a destination floor and a corresponding operating mode. In FIG. 2A, the corresponding call input options are shown symbolically next to the selection input fields 40.1 and 40.2. During initial startup, the technician can select one of the selection input fields 40.1, 42.1 (symbolized by a finger) to configure the elevator operating device 4 according to one of the two operating modes. In one embodiment, the elevator operating device 4 can be configured to substantially configure itself (e.g., without significant assistance by the technician) according to the selected operating mode. A central control device (50) of the elevator operating device 4 can load, for example, data and computer instructions (software) from a storage device (32) according to the selected operating mode. A person skilled in the art will recognize that the configuration input mask 41 can display additional display and/or input fields. Submasks can also be defined that can be opened from the configuration input mask 41.

In FIG. 2B, the touchscreen 5 displays two direction of travel fields 40.2 on the graphical user surface 36. The elevator operating device 4 can therefore be configured to input a direction call. For example, during said startup process, the technician has selected the selection input field 40.1 shown FIG. 2A. The touchscreen 5 shown in FIG. 2C displays an example number of fields or buttons on its graphical user surface 36. These fields or buttons are also referred to herein as destination floor fields 42.2. In this case, the technician has selected the selection input field 42.1 shown in FIG. 2A during the initial startup.

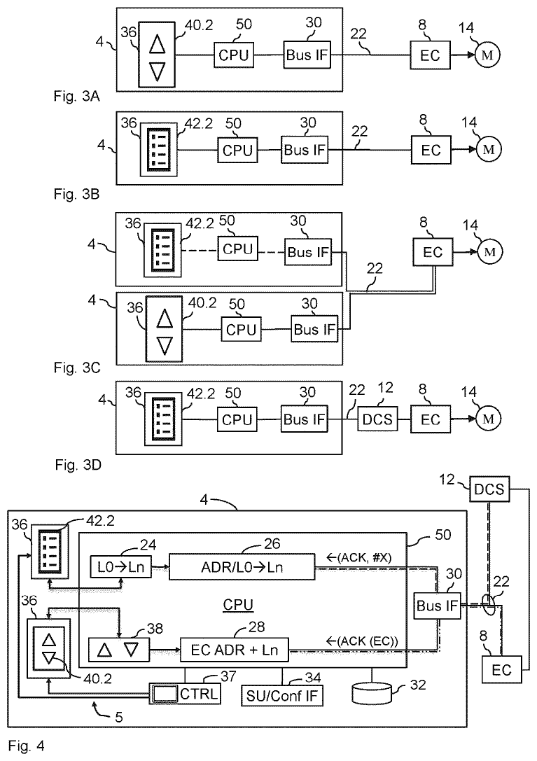

FIG. 3A-3D show various application examples for an elevator operating device 4 according to the present disclosure. The elevator operating device 4 is represented by the graphical user surface 36, a control device 50 (CPU) and a bus interface device 30 (Bus IF). The communication bus system 22 connects the bus interface device 30 to a control system component (8, 12) of the elevator system 1, wherein the elevator controller 8 activates the drive machine 14. The elevator operating device 4 according to the present disclosure can be configured for one of these example applications. This may be advantageous because, depending on the building 2, it may be desirable or necessary that all elevator operating devices 4 in the building 2 have the same external design and shape, regardless of the operating mode for which they are configured.

In FIG. 3A, the elevator operating device 4 shown can be configured for inputting the direction call and the corresponding operating mode. A person skilled in the art will recognize that any other elevator operating devices 4 provided in the elevator system 1 can also be configured for this operating mode. The graphical user surface 36 displays the direction of travel fields 40.2. The elevator operating device 4 may send an input direction call as a direction call message via the bus communication system 12 to the elevator controller 8 (up/down direction controller), which may accordingly activate the drive machine 14 to provide the car 10 on a boarding floor. The direction call message can comprise, for example, an ID of the elevator operating device 4 (sending said message) and the desired direction of travel. The location of the elevator operating device 4 and the boarding floor may be obtained from the ID. Once the person has entered the car 10, they can input the desired destination floor as a car call on the elevator operating device 11 located therein. If the elevator controller 8 detects that the car 10 is ready for departure, e.g., a door sensor or safety circuit indicates that the elevator door 6 is closed, the elevator controller 8 may activate the drive machine 14 according to the car call to move the car 10 to the destination floor.

In FIG. 3B, the elevator operating device 4 shown can be configured for inputting a destination floor and the corresponding operating mode. A person skilled in the art will recognize that any other elevator operating devices 4 provided in the elevator system 1 can also be configured for this operating mode. The graphical user surface 36 displays the destination floor fields 42.2. The elevator operating device 4 may send an input destination floor call as a destination floor call message via the bus communication system 12 to the elevator controller 8, which may accordingly activate the drive machine 14 to provide the car 10 on the boarding floor. The destination floor call message can comprise, for example, an ID of the elevator operating device 4 (sending said message), from which the location of the elevator operating device 4 or the boarding floor can be determined.

In one embodiment, the destination floor call message can comprise information about the desired destination floor. The destination floor can be stored in the elevator controller 8. If the car 10 provided on the boarding floor is ready for departure after the person has entered on the boarding floor, e.g., a door sensor or safety circuit indicates that the elevator door 6 is closed, the elevator controller 8 may move the car 10 to the (stored) destination floor. In another embodiment, the destination floor call message may not contain any information about the destination floor. According to this embodiment, it may be stored in the elevator operating device 4 until the car 10 is ready for departure. The elevator operating device 4 may then transmit the destination floor in another message addressed to the elevator controller 8. In both embodiments, the movement to the destination floor may take place without the person in the car 10 having to make a car call. In one embodiment of the elevator system 1, it is possible for this not to be provided.

In FIG. 3C, elevator operating devices 4 are provided in the elevator system 1 for different operating modes. This means that the elevator system 1 can comprise both elevator operating devices 4 for inputting destination floors and elevator operating devices 4 for inputting direction calls. Such an elevator system 1 can be provided, for example, if a building 2 requires the ability to input destination calls on at least one floor L0, L, Ln, for example, in an entrance hall with high traffic of people; as is also shown in FIG. 1. The elevator operating device 4 arranged on this floor L0 can be configured accordingly, and its graphical user surface 36 displays the destination floor fields 42.2. On other floors L, Ln, the elevator operating devices 4 each display the direction of travel fields 40.2 on their graphical user surfaces 36. The calls input at these elevator operating devices 4 (direction calls, destination floor calls) may each be processed as described in conjunction with FIG. 3A and FIG. 3B.

In FIG. 3D, the elevator system 1 is equipped with a destination call control device 12 (DCS). A person skilled in the art will recognize that an elevator system 1 with a destination call control device 12 can be installed, in particular, in buildings with a large number of floors and can have more than one car 11 (elevator). A plurality of elevators of the elevator system 1 can be organized into one or more elevator groups. Accordingly, the elevator operating device 4 can be configured for inputting a destination floor, and its graphical user surface 36 displays the destination floor fields 42.2. In the schematic view in FIG. 3D, the elevator operating device 4 is connected to the destination call control device 12, which is also connected to the elevator controller 8. The destination call control device 12 may process the input destination floor (e.g., a destination call) according to an allocation algorithm. The destination call may determine the boarding floor (e.g., using the ID for the elevator operating device 4) and the destination floor. The allocation algorithm may determine an elevator to serve the destination call. The destination call control device 12 can thereby activate the elevator controller 8 of the assigned elevator.

The call allocation can be carried out by the destination call control device 12 alone (centralized) or in cooperation with the elevator operating devices 4 of the elevator system 1 (decentralized). Such allocation algorithms are known to a person skilled in the art. A (decentralized) allocation algorithm in cooperation with the elevator operating devices is described, for example, in: Koehler, Jana, et al., An AI-Based Approach to Destination Control in Elevators, AI Magazine, vol. 23, no. 3, 2002, pp. 59-78. According to a decentralized allocation algorithm, the elevator operating device 4, at which the destination call is input, may send the information in the destination call via the bus communication system 12 to each elevator (or its computer unit) of the elevator system 1. Each elevator may separately evaluate whether it is possible to serve the destination call and how much “effort” it would be (the “effort” can also be referred to as “costs”) to serve the destination call. Each elevator may send a response back to the (requesting) elevator operating device 4. The response may state whether the destination call can be served or not, and if so, how much effort would be required. After the elevator operating device 4 has received all responses, it may select the elevator requiring the least amount of effort. This selection may then be sent with another message to the elevator controller of the corresponding elevator. In this embodiment, all the elevator operating devices 4 and the computer units can represent the destination call control device 12.

FIG. 4 is a schematic illustration of one embodiment of an elevator operating device 4. In this illustration, the elevator operating device 4 is connected to the elevator controller 8 by the communication bus system 22 (or via the destination call control device 12). The elevator operating device 4 comprises a bus interface device 30 (Bus IF), a control device 50 (CPU), a storage device 32, a configuration interface device 34 and a screen system with a screen controller 37 (CTRL) and a touchscreen 5 (for illustration purposes, exemplary displayable graphical user surfaces 36 with direction of travel fields 40.2 or destination floor fields 42.2 are shown).

The bus interface device 30 is connected to the control device 50 and designed to communicate with the elevator controller 8 via the communication bus system 22. The communication bus system 22 can comprise, for example, a CAN bus system (controller area network), with use being made of the transmission method, communication protocol and frame structure thereof. In another embodiment, the communication bus system 22 may comprise a proprietary bus system, for which a transmission method, a communication protocol and a frame structure may also be specified. One such proprietary bus system is, for example, a Biobus system disclosed in EP 1 876 129 B1. A person skilled in the art will recognize that the present disclosure is not limited to these bus systems and can also be used in conjunction with other bus systems that are suitable for elevator systems.

The bus interface device 30 can be configured to communicate according to one of these bus technologies. In one embodiment, the bus interface device 30 can store data and instructions for at least one characteristic of said bus technologies, e.g., the transmission method, the communication protocol and/or the frame structure of one of these bus technologies. The bus interface device 30 thus may store the characteristics of the aforementioned bus technologies, wherein one of these bus technologies may be used during operation.

In one embodiment, the bus interface device 30 may automatically recognize the communication bus system 22 to which it is connected and the bus technology according to which this communication bus system 22 operates, for example, depending on the voltage level of the communication bus system 22 (e.g., approximately 5 V for a CAN bus system, and approximately 24 V for a Biobus system). In another embodiment, the bus technology of the communication bus system 22 can be input into the elevator operating device 4 during the configuration process. Since the bus interface device 30 may store the characteristics of the aforementioned bus technologies, the elevator operating device 4 may be bus-independent, e.g., it can be selectively connected to any communication bus system 22 that is designed according to one of the aforementioned bus technologies.

The storage device 32 is connected to the control device 50 and may store configuration data and electronic instructions for the operating modes mentioned in conjunction with FIG. 3A-3D. These data and instructions can be stored during manufacture of the elevator operating device 4 (or before delivery thereof) such that the stored data and instructions are available for the aforementioned operating modes during configuration in the building 2. In another embodiment, the data and instructions for the operating mode selected during configuration (cf. FIG. 2A) may be made available by the elevator controller 8, downloaded and stored in the storage device 32 as part of the configuration process. Storage devices and storage technologies (e.g., semiconductor memories) suitable for storing these data and instructions are known to a person skilled in the art.

The control device 50 can be configured to activate the screen system so that it displays the graphical user surface 36 in a suitable manner for the configuration. The function of a screen system with a touchscreen 5, its activation and the generation of a graphical user surface are known to a person skilled in the art. The control device 50 can activate the screen system, for example, so that the touchscreen 5 displays one of the graphical user surfaces 36 shown in FIG. 2A-2C. A person skilled in the art will recognize that these graphical user surfaces 36 are examples, may include additional information or content, and/or may be designed in a different manner. A person skilled in the art will also recognize that, for example, a call acknowledgment and/or elevator information (e.g., an indication of the elevator assigned to serve the elevator call) can be communicated with the graphical user surface 36. The call acknowledgment and the elevator information can be visually and/or acoustically perceptibly communicated.

The control device 50 can be configured to process stored data and execute stored instructions (e.g., computer programs), including reading data and instructions from the storage device 32 and/or storing them therein in order to operate the elevator operating device 4 according to one of the aforementioned operating modes. The control device 50 can also be configured to operate the configuration interface device 34 as part of the above-mentioned configuration. In FIG. 4, the operating mode for inputting the direction of travel is illustrated in the lower half of the control device 50, while the operating mode for inputting a destination floor is illustrated in the upper half.

The processing of a direction of travel input in a direction of travel field 40.2 is illustrated in FIG. 4 by a call detection module 38 and a call processing module 28 (EC ADR+Ln) in the control device 50. The call detection module 38 and the call processing module 28 are shown in a path between the bus interface device 30 and the graphical user surface 36 (direction of travel fields 40.2). The call detection module 38 may detect the desired direction of travel and may make this information (the person's travel request) available to the call processing module 28. The call processing module 28 thus may generate a request message (data packet) which is addressed to the elevator controller 8 (EC ADR) and comprises floor information (EC ADR+Ln), e.g., an indication of the floor Ln on which the elevator operating device 4 is arranged and on which a car 10 is to be provided. The request message can also specify the direction of travel. If the elevator system 1 comprises a plurality of elevators (e.g., a plurality of cars 10), an algorithm of the elevator controller 8 can use the direction of travel information to select a car 10 that can serve this elevator call, for example, the fastest. According to an example algorithm, all other elevators can be queried as to whether and with what amount of effort they can be served by one elevator.

The bus interface device 30 may feed the request message into the communication bus system 22 in accordance with the communication protocol defined for the communication bus system 22. The elevator controller 8 can acknowledge receipt of the request message with an acknowledgment message (ACK (EC)) via the communication bus system 22 and may make the assigned car 10 available on the boarding floor. Depending on the situation, the elevator controller 8 may initiate the movement of the assigned car 10 to the boarding floor. The elevator operating device 4 can acknowledge the input elevator call to the person, for example, visually perceptibly with the graphical user surface 36. For illustration purposes, the communication between the call processing module 28 and the elevator controller 8 is represented by different line types. In the car 10, the person can input the desired destination floor at the elevator operating device 8 provided therein.

The processing of a destination floor input at a destination floor field 42.2 is illustrated in FIG. 4 by a destination floor detection module 24 and a destination floor processing module 26 (ADR/L0→Ln) 28 (EC ADR+Ln) in the control device 50. The destination floor detection module 24 and the destination floor processing module 26 are shown by way of example in a path between the bus interface device 30 and the graphical user surface 36 (destination floor fields 42.2). The destination floor detection module 24 may detect the desired destination floor and can make this destination information available to the destination floor processing module 26. As explained above, inputting a destination floor on a floor can provide the boarding floor (in FIG. 1 and FIG. 4 this is the floor L0) and the destination floor. From this (e.g., the destination floor above or below the boarding floor) the direction of travel of the car 10, which transports the person to the desired destination floor, may also be determined.

If the elevator operating device 4 shown in FIG. 4 is used in an elevator system 1 according to FIG. 3B, the destination floor processing module 26 (ADR/L0→Ln) may generate a request message (data packet) addressed to the elevator controller 8 and comprising floor information, e.g., indicating the floor L0 on which the elevator operating device 4 is arranged and on which a car 10 is to be provided, and indicating the destination floor Ln. The bus interface device 30 may feed the request message into the communication bus system 22 in accordance with the communication protocol defined for the communication bus system 22. After receiving the request message, the elevator controller 8 may store the destination floor and can acknowledge receipt of the request message with an acknowledgment message (ACK, #X) via the communication bus system 22. The acknowledgment message can indicate the assigned car 10 (#X). The car 10 serving the elevator call may accordingly be activated and sent to the boarding floor. Depending on the position of the car 10, the drive machine 14 sometimes may move the car 10 to the boarding floor. If the elevator controller 8 detects that the car 10 is ready for departure, e.g., a door sensor or safety circuit indicates that the elevator door 6 is closed, the elevator controller 8 may activate the drive machine 14 according to the stored destination floor to move the car 10 to the destination floor.

If the elevator operating device 4 is used in an elevator system 1 comprising a destination call control device 12 according to FIG. 3D, the elevator operating device 4 can be configured for inputting a destination call. In one embodiment, the elevator system 1 can comprise a plurality of cars 10 or elevators, wherein all elevator operating devices 4 of the elevator system 1 may be configured for inputting a destination call. The destination floor processing module 26 may process the destination call by generating a request message (data packet) which is addressed to the destination call control device 12 and can comprise floor information, e.g., an indication of the floor L0 on which the elevator operating device 4 is arranged and on which a car 10 is to be provided. The bus interface device 30 may feed the request message into the communication bus system 22 in accordance with the communication protocol defined for the communication bus system 22.

The destination call control device 12 may execute an allocation algorithm, e.g., as disclosed in the Koehler document cited herein, to determine a car 10 that can serve the destination call in the “most cost-effective” manner. This allocation can be carried out very quickly such that receipt of the request message can be acknowledged with an acknowledgment message (ACK, #X) via the communication bus system 22, which can also indicate the elevator or car 10 (#X) that is allocated to serve the destination call. The elevator operating device 4 can communicate the assigned car 10 to the person. The destination call control device 12 can activate the elevator controller 8 of the assigned elevator to move the assigned car 10 to the boarding floor L0 (if it is not already there) with its drive machine 14 and to make it available for boarding. The elevator door 6 may be opened for example. If the car 10 is ready on the boarding floor, the elevator controller 8 can generate a signal which may be transmitted to the destination call control device 12. The destination call control device 12 may react by transmitting the destination floor to the elevator controller 8. The car 10 may then be moved from the boarding floor to the destination floor. A car call, e.g., inputting the destination floor in the car 10, is usually not possible.

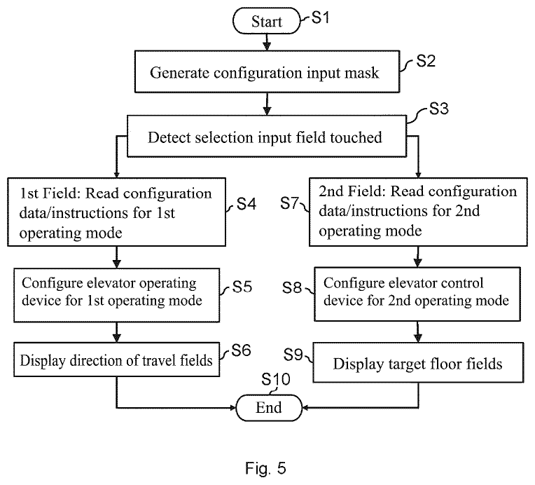

Using the understanding of the basic system components of the elevator system 1 and its functionalities described herein, an example method for operating an elevator operating device 4, as can be used in the elevator system 1 shown in FIG. 1, is described herein on the basis of FIG. 5. The description is made with reference to the operation of the elevator operating device 4 after installation in the elevator system 1 or in the building 2 and connection to the communication bus system 22. The elevator operating device 4 is supplied with electrical energy. The method begins with a step S1 and ends with a step S10.

In a step S2, the configuration input mask 41 may be generated. The configuration mask 41 may be shown on the graphical user surface 36, which the touch-sensitive screen 5 of the screen system may display under the control of the control device 50 of the elevator operating device 4. As shown, for example, in FIG. 2A, the configuration mask 41 comprises a first selection input field 40.1 for the first operating mode of the elevator operating device 4 and a second selection input field 42.1 for the second operating mode of the elevator operating device 4.

In a step S3, a touched selection input field 40.1, 42.1 may be detected. Detection may be done by the screen system. Depending on the detected selection input field 40.1, 42.1, the method proceeds to a step S4 or to a step S7.

In step S4, detection that the first selection input field 40.1 has been touched can cause configuration data and electronic instructions for the first operating mode to be read from the storage device 32. In a step S5, the elevator operating device 4 may then be configured for the first operating mode according to the configuration data and electronic instructions that are read. Configured in this way, the direction of travel fields 40.2 may be displayed in a step S6, as shown in FIG. 2B, for example.

In step S7, detection that the second selection input field 42.1 was touched can cause configuration data and electronic instructions for the second operating mode to be read from the storage device 32. In a step S8, the elevator operating device 4 may be configured for the second operating mode according to the configuration data and electronic instructions that are read. Configured in this way, the destination floor fields 42.2 may be displayed in a step S9, as shown in FIG. 2C, for example. In both branches, the method ends in step S10.

1-13. (canceled)

14. An elevator operating device comprising:
a bus interface device configured to communicate with an elevator controller of an elevator system via a communication bus system;
a storage device configured to store configuration data and electronic instructions for selectable operating modes of the elevator operating device, wherein a first operating mode is configured to process an elevator call that indicates a direction of travel input, and wherein a second operating mode is configured to process an elevator call that indicates an input destination floor;
a screen system comprising a touch-sensitive screen and configured to display a graphical user surface on the touch-sensitive screen; and
a control device communicatively connected to the bus interface device, the screen system and the storage device, wherein the control device is configured to read the configuration data and the electronic instructions for a selected operating mode from the storage device and to operate the elevator operating device according to the selected operating mode.

15. The elevator operating device of claim 14, wherein the control device is configured to:
activate the screen system;
display a configuration input mask on the graphical user surface, wherein the configuration input mask comprises a first selection input field for the first operating mode and a second selection input field for the second operating mode;
configure the elevator operating device according to the configuration data and the electronic instructions for the first operating mode if the first selection input field is touched; and
configure the elevator operating device according to the configuration data and the electronic instructions for the second operating mode if the second selection input field is touched.

16. The elevator operating device of claim 15, wherein the control device is configured to:
activate the screen system in the first operating mode to display direction of travel fields according to the first operating mode on the graphical user surface; and
activate the screen system in the second operating mode to display destination floor fields according to the second operating mode on the graphical user surface.

17. The elevator operating device of claim 14, wherein the control device is configured to:
generate a first request message in the first operating mode which comprises an address of the elevator controller, an ID of the elevator operating device and a direction of travel, and to send these to the elevator controller via the bus interface device and the communication bus system; and
generate a second request message in the second operating mode which comprises the address of the elevator controller and the ID of the elevator operating device and an indication of a destination floor, and to send these to the elevator controller via the bus interface device and the communication bus system.

18. The elevator operating device of claim 15, wherein the control device is configured to:
generate a first request message in the first operating mode which comprises an address of the elevator controller, an ID of the elevator operating device and a direction of travel, and to send these to the elevator controller via the bus interface device and the communication bus system; and
generate a second request message in the second operating mode which comprises the address of the elevator controller and the ID of the elevator operating device and an indication of a destination floor, and to send these to the elevator controller via the bus interface device and the communication bus system.

19. The elevator operating device of claim 16, wherein the control device is configured to:
generate a first request message in the first operating mode which comprises an address of the elevator controller, an ID of the elevator operating device and a direction of travel, and to send these to the elevator controller via the bus interface device and the communication bus system; and
generate a second request message in the second operating mode which comprises the address of the elevator controller and the ID of the elevator operating device and an indication of a destination floor, and to send these to the elevator controller via the bus interface device and the communication bus system.

20. The elevator operating device of claim 14, wherein data and instructions for communication bus technologies, in particular, at least one of their transmission methods, communication protocols or frame structures, are stored in the bus interface device, and wherein the bus interface device is configured to communicate via the communication bus system according to one of the communication bus technologies stored in the bus interface device.

21. The elevator operating device of claim 15, wherein data and instructions for communication bus technologies, in particular, at least one of their transmission methods, communication protocols or frame structures, are stored in the bus interface device, and wherein the bus interface device is configured to communicate via the communication bus system according to one of the communication bus technologies stored in the bus interface device.

22. The elevator operating device of claim 16, wherein data and instructions for communication bus technologies, in particular, at least one of their transmission methods, communication protocols or frame structures, are stored in the bus interface device, and wherein the bus interface device is configured to communicate via the communication bus system according to one of the communication bus technologies stored in the bus interface device.

23. An elevator system, comprising:
an elevator controller;
an elevator car configured to move between floors of a building under the control of the elevator controller and driven by a drive machine;
a communication bus system; and
the elevator operating device of claim 14, wherein the elevator operating device is communicatively connected to the communication bus system and is arranged on the floors and configured for inputting an elevator call.

24. The elevator system of claim 23, wherein the elevator controller is communicatively connected to the communication bus system and is configured, upon receipt of the elevator call indicating a direction of travel from the elevator operating device arranged on a first floor and configured for the first operating mode, to provide the elevator car on the first floor, and, upon receipt of a car call input in the elevator car and indicating a destination floor, to move the elevator car to the destination floor.

25. The elevator system of claim 23, wherein the elevator controller is communicatively connected to the communication bus system and is configured, upon receipt of the elevator call indicating a destination floor from the elevator operating device arranged on a first floor and configured for the second operating mode, to provide the elevator car on the first floor, and, upon receipt of a status signal indicating that an elevator door of the elevator car is closed, to move the elevator car to the destination floor indicated in the elevator call.

26. The elevator system of claim 23, further comprising a destination call control device which is communicatively connected to the elevator controller and the communication bus system.

27. A method for operating the elevator operating device of claim 14 in the elevator system, wherein the elevator operating device is connected to the communication bus system of the elevator system, said method comprising:
generating a configuration input mask on the graphical user surface which the touch-sensitive screen of the screen system displays under the control of the control device of the elevator operating device, wherein the configuration input mask comprises a first selection input field for the first operating mode of the elevator operating device and a second selection input field for the second operating mode of the elevator operating device;
reading the configuration data and the electronic instructions for the first operating mode from the storage device and configuring the elevator operating device for the first operating mode according to the configuration data and the electronic instructions that are read upon detection by the screen system that the first selection input field has been touched; and
reading the configuration data and the electronic instructions for the second operating mode from the storage device and configuring the elevator operating device for the second operating mode according to the configuration data and the electronic instructions that are read upon detection by the screen system that the second selection input field has been touched.

28. The method according to claim 27, further comprising:
activating the screen system with the control device to display direction of travel fields on the graphical user surface in the first operating mode, and
activating the screen system with the control device to display destination floor fields on the graphical user surface in the second operating mode.

29. The method of claim 27, further comprising:
generating, in the first operating mode, a first request message with the control device, wherein the first request message comprises an address of the elevator controller, an ID of the elevator operating device and a direction of travel, and sending the first request message via the bus interface device and the communication bus system to the elevator controller, and
generating, in the second operating mode, a second request message with the control device, wherein the second request message comprises the address of the elevator controller, the ID of the elevator operating device and information regarding a destination floor, and sending the second request message via the bus interface device and the communication bus system to the elevator controller.

30. The method of claim 28, further comprising:
generating, in the first operating mode, a first request message with the control device, wherein the first request message comprises an address of the elevator controller, an ID of the elevator operating device and a direction of travel, and sending the first request message via the bus interface device and the communication bus system to the elevator controller, and
generating, in the second operating mode, a second request message with the control device, wherein the second request message comprises the address of the elevator controller, the ID of the elevator operating device and information regarding a destination floor, and sending the second request message via the bus interface device and the communication bus system to the elevator controller.

31. The method of claim 27, wherein data and instructions for communication bus technologies, in particular, at least one of their transmission methods, communication protocols or frame structures, are stored in the bus interface device and wherein the bus interface device is configured to communicate via the communication bus system according to one of the communication bus technologies stored in the bus interface device.

32. The method of claim 28, wherein data and instructions for communication bus technologies, in particular, at least one of their transmission methods, communication protocols or frame structures, are stored in the bus interface device and wherein the bus interface device is configured to communicate via the communication bus system according to one of the communication bus technologies stored in the bus interface device.

33. The method of claim 29, wherein data and instructions for communication bus technologies, in particular, at least one of their transmission methods, communication protocols or frame structures, are stored in the bus interface device and wherein the bus interface device is configured to communicate via the communication bus system according to one of the communication bus technologies stored in the bus interface device.
